(19) United States
(12) Patent Application Publication
(10) Pub. No.: US 2005/0173309 A1
(43) Pub. Date: Aug. 11, 2005

(54) Hydrogravity system and process for reclaiming and purifying a solid, multiple domain feedstock

(75) Inventors: Joseph E. Bork, Westlake, OH (US); Stephen C. Paspek JR., Broadview Heights, OH (US); Alan Schroeder, Cleveland, OH (US); Ullrich Engel, Michigan City, IN (US)

Correspondence Address: Daniel J. Hudak;HUDAK, SHUNK & FARINE CO. LPA, Suite 307, 2020 Front Street, Cuyahoga Falls, OH, 44221, US

(73) Assignee: PLASTICS RECLAIMING TECHNOLOGIES, INC.

(21) Appl. No.: 10/774,158

(22) Filed: Feb. 6, 2004

(51) Int. Cl. B03B 5/28

(52) U.S. Cl. 209/172

(57) ABSTRACT

The hydrogravity separation of a multiple domain solid feedstock comprises granulating the feedstock to produce particles substantially of individual domain components having different densities. A dispersion mixer having a high shear and/or turbulent zone is utilized to disperse agglomerated particles and a quiescent hydrogravity tank is utilized to effect binary separation of one or more of the heaviest or one or more of the lightest feedstock components by utilizing an aqueous solution having a specific gravity intermediate of the various components. A high degree of purity is obtained by feeding particles of a selected component to a plurality of sequential dispersion mixers and hydrogravity separation tanks. In a similar manners remaining thermoplastic particle components can be selectively removed and purified.

### FIELD OF THE INVENTION

The present invention relates to reclaiming one or more selective, different density solid components, such as plastic, metal, etc., which initially can be physically bonded to each other, from a multiple domain solid feedstock. More specifically, the present invention relates to using binary hydrogravity separation of small sized particles of the solid multiple domain feedstock to selectively remove at least one of the different density components in a quiescent settling tank containing an aqueous solution having a specific gravity intermediate to one or more of the heaviest feedstock components or intermediate to one or more of the lightest thermoplastic feedstock components.

### BACKGROUND OF THE INVENTION

Heretofore, plastics have been selectively dissolved by certain solvents and separated from other plastics or non-plastic materials as by filtration. This format requires high temperatures, and potential problems with solvent vapors, and the like.

### SUMMARY OF THE INVENTION

Articles and products which serve as feedstock and contain multiple domains such as layers or regions of two or more different solid components are reclaimed by a binary hydrogravity separation. Initially, the feedstock is granulated to reduce the size of the multiple components into small particles of substantially a single component and washed to remove dirt. Optionally, but desirably, fines can be removed. The particles are then fed to a hydrogravity separation tank containing an aqueous solution having a specific gravity which is intermediate to the specific gravity of one or more of the heaviest components or which is intermediate to the specific gravity of one or more of the lightest components so that the selected component(s) can be readily removed. A plurality of processing units each preferably containing a hydrogravity separation tank and a dispersion mixer to disperse agglomerated particles enable reclaiming of selected component(s) in a substantially pure form. In a similar manner, the various remaining thermoplastic components can be separated and purified.

### BRIEF DESCRIPTION OF THE DRAWINGS

FIG. 1 is a schematic flow diagram of one embodiment of a hydrogravity reclaiming system of the present invention containing different operation stages for removal and purification of solid components having different specific gravities;

FIG. 2 is a side elevation of a hydrogravity separation tank;

FIG. 3 is an end side elevation of the hydrogravity separation tank; and

FIG. 4 is a cross-sectional view of a dispersion mixer which disperses agglomerated particles.

### DETAILED DESCRIPTION OF THE INVENTION

The system and process of the present invention for reclaiming individual thermoplastic components relate to a feedstock comprising solid, multiple domain components having different densities or specific gravities. One large class of components are various plastics such as thermoplastic or thermoset polymers. The polymers can either be a homopolymer or a copolymer. However, not included within the plastic class are various melt blended compounds inasmuch as they do not contain a domain of a component but rather contain multiple components on a molecular scale. Thus, a feedstock of the present invention generally contain less than about 10%, desirably less than about 5%, and preferably less than about 1% by weight of a melt blended material based upon the total weight of the feedstock. Non-plastic components include metals, various woods, paper, and the like. The multiple domain components are often in the form of layers, regions, areas, and the like.

Examples of articles or products utilized as feedstocks in various embodiments of the invention include insulated wire or cable including metal such as aluminum, copper, or steel; plastic laminates or layered items; plastics items containing inorganic or other non-plastics; extrusion “bleeders”; recycled materials containing thermoplastics; vinyl-clad materials such as various window frames; door frames, and the like; automotive components including laminated or layered thermoplastic and/or thermoset parts; and the like.

Examples of specific thermoplastic polymers which can be separated include, but is not limited to, polyolefins such as polyethylene and polypropylene; styrenic polymers; acrylic polymers; polyvinyl esters such as polyvinyl acetate; polyvinyl alcohol; chlorine-containing polymers such as polyvinyl chloride and polyvinylidene chloride; various fluorocarbon polymers such as polytetrafluoroethylene, polyvinyl fluoride, and the like; polyamides; polyesters; polyurethanes; polycarbonates; copolymers of the above, and the like.

Examples of specific thermoset polymers include various phenolic resins, various amino resins, various polyester resins, epoxy resins, various urethanes including urethane foams, various silicone resins, and the like including copolymers of various thermoset resins.

Other solid items which can be reclaimed by hydrogravity separation include metals such as iron, nickel, platium, platinum, silver, copper, gold, zinc, aluminum, tin, antimony, titanium, chrome, and the like. Still other solid items include various types of wood including plywood, particle board, etc., various types of paper including cardboard, corrugated paper, and the like.

Still other solid items which can be reclaimed include inorganic fillers such as silica oxides, metal carbonates, clay, limestone, alumina silicates, and the like.

### Overall Operation

The overall reclaiming system and process include, but is not limited to, the following operation stages.

Granulation involves sizing the feed stock by cutting the same into suitable lengths and then breaking the same into sized particles of substantially separated domains, desirably washing or air separating the particles to remove dirt, dust, grime and the like, and optionally screening the particles to remove fines which may hinder or inhibit subsequent operations.

A binary hydrogravity separation occurs in a quiescent tank preferably having steep angled walls generally greater than the angle of repose to prevent particle buildup thereon. The specific gravity of the aqueous solution, which is achieved by adding one or more salts, which include metal hydroxides, metal oxides, and metal complexes, to water is selected to achieve the separation of one or more of the lightest feedstock components, or one or more of the heaviest feedstock components. Thus, an intermediate specific gravity can be selected so that granulated particles added to hydrogravity separation tank will be separated into one or more lighter components as well as one or more heavier components. Alternatively and often preferred, the specific gravity of the aqueous solution is slightly greater than the specific gravity of only the lightest solid component, or is slightly less than the specific gravity of the heaviest solid component. The component(s) selected to be reclaimed is desirably added to at least one additional gravity separation tank and then to preferably a plurality of additional separation tanks to further increase the yield and purify the selected, reclaimed component.

While the preferred embodiment of the present invention relates to an aqueous solution, it is never the less within the scope of the present invention to utilize non-aqueous solutions such as silicone solutions, oils including hydrocarbon and halohydrocarbon oils, dry cleaning fluids, and even liquid ammonia or carbon dioxide.

Dispersion mixers are preferably utilized before each hydrogravity separation tank to sever, divide, and especially to break up agglomerated particles of the feedstock before they are added to a hydrogravity separation tank.

The selected separated particles from the last hydrogravity tank are collected, washed, dried, and utilized for any desirable purpose such as reuse or resale.

In a similar manner, each remaining domain(s) or component(s) is selectively removed and purified.

### System and Processing Components

The present invention will now be described with respect to reclaiming one or more solid components from an article such as an insulated copper cable, it being understood that, as noted above, generally any article or product having multiple domains of different plastics or other components such as metal, wood, etc., can serve as feedstock which is reclaimed with a high degree of purity.

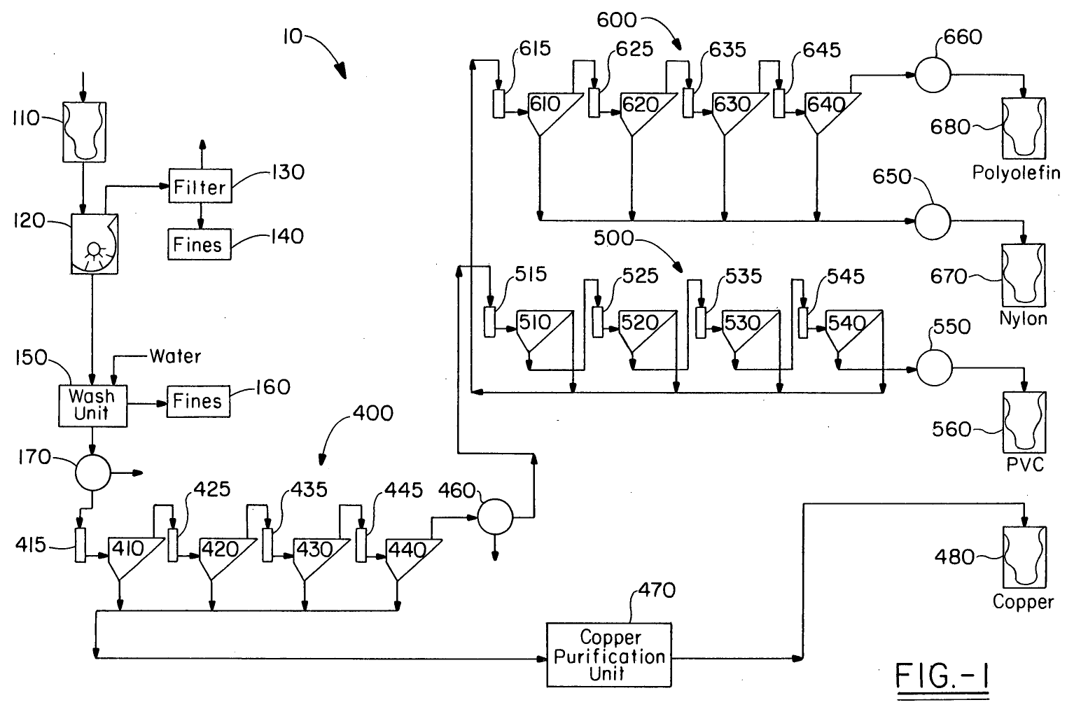

Referring to FIG. 1, a hydrogravity system and process for reclaiming and purifying a solid feedstock is generally indicated by reference number 10. In one embodiment, the reclaimed article is a wire cable which contains a plurality of separated copper wires each surrounded with a thermoplastic such as polyethylene or other domain thermoplastic with the same being contained or encapsulated within an insulating thermoplastic such as polyvinyl chloride or other domain thermoplastic. The insulated cable has an outer jacket which is generally a thermoplastic nylon or other domain thermoplastic. In other embodiments, any number of domains can be present.

The solid article, such as a copper cable is generally precut at an angle into lengths generally greater than 4 millimeters (mm) and fed from feedstock container 110 to granulator 120. Generally any type of cutting device or machine can be utilized with a reel type cutting blade being desired.

The purpose of the granulator is to size, that is to break, chop, shred, etc. the precut lengths into particles of 4 mm or less and desirably from about 0.5 mm or about 1 to about 2 mm or about 3 mm or about 4 mm. The granulator reduces the feedstock containing layers of different domains, regions, etc., into small particles containing substantially only one domain or component, e.g. thermoplastic or metal. That is, since the various layers, regions, etc., of the feedstock are only physically bonded, granulation of the same readily separates the various domains or components to produce particles of substantially only a single domain or component. Thus, the amount of any particles having two or more thermoplastic domains or components therein is very small, generally less than about 5% by weight, desirably less than about 3% by weight, and preferably less than about 1% by weight, or no percent by weight based upon the total weight of the feedstock. Granulators for producing metal and/or thermoplastic particles are well known to the art and to the literature and generally any suitable granulator 120 can be utilized such as a CMG, made in Italy. For reasons set forth below, fines are desirably removed and filtered in unit 130 and collected in unit 140.

The granulated particles often contain dirt, grime, and fines and are thus fed to wash unit 150 wherein they are mixed under high agitation to create a suspension of the particles in water. Any type of high agitation mixing tank can be utilized with high shear agitation and/or turbulent flow being preferred. The washing step may be continuous or batch. The amount of the granulated article, such as thermoplastic and copper feedstock is desirably such that the solids loading of the slurry in the wash unit is desirably from about 10% to about 40% by weight. Generally any soap such as laundry soap or any conventional surfactant, detergent, or wetting agent, known to the art and to the literature which is non-foaming or low foaming can be utilized so long as it aids in wetting the granulated thermoplastic and copper particles.

The removal of fines from the particular article feedstock, while optionally, is often an important aspect of the present invention since otherwise, they generally clog the reclaiming system because they generally do not settle or float in the hydrogravity tanks but remain in suspension. Generally any conventional method of removing the fines can be utilized such as centrifuging, air separation, or desirably screening. For example, a screen containing openings of generally less than about 1.0 mm and desirably less than about 0.5 mm can be utilized to permit the fines to fall there through. A vibrating screen is preferred. In addition to the fines, dirt, and grime, the surfactant or soap solution also falls through the screen. A series of one or more spray bars can be utilized to spray a solution or water onto the retained material to aid in removing fines, dirt, grime, soap or detergent solution therefrom. The fines can be collected in container 160.

The washed thermoplastic and copper particles are substantially dewatered so when they are fed to a hydrogravity separator tank, dilution of the aqueous salt solution is prevented. Generally any type of drying process or apparatus 170 can be utilized with a vibratory screen or a conventional spin dryer being preferred to remove the excess solution leaving a product having about 0% or about 0.1% to about 15% and desirably from about 3% to about 7% by weight of solution.

With respect to the embodiment of copper cable particles, although generally any type of feedstock can be utilized, in the various reclaiming stages a selected component is separated out such as a metal or copper in a first stage. The washed and granulated dewatered feedstock comprising different domain thermoplastic particles as well as copper particles is continuously fed preferably to a plurality of sequential hydrogravity separator tanks wherein the copper, or other non-thermoplastic materials is separated from the thermoplastic components. Desirably before each tank they are fed to a dispersion mixer for de-agglomeration and subsequently fed to the mid portion of a sequential hydrogravity tank. By mid portion it is meant from about 10% to about 90%, desirably from about 20% to about 80%, and preferably from about 30% to about 70% of the total aqueous solution height in the tank. Another important aspect of the present invention in one embodiment is the utilization of an aqueous solution having a selected specific gravity which permits binary separation of one or more of the heaviest components to be separated out from the bottom of the hydrogravity tank. Alternatively, a specific gravity can be selected which permits one or more of the lightest components to float to the top of the tank and to be removed therefrom. As previously noted, the one or more selected solid component particles to be reclaimed are sequentially subjected to a plurality of hydrogravity tanks having essentially the same specific gravity to obtain a high yield and purity of the selected components. Yet another important aspect is that the aqueous solution has a relatively low viscosity to allow ready separation of the desired component. The viscosity of the aqueous solution will vary depending upon the types of the particles, the size and shape thereof, and type of the one or more salts. A rule of thumb is that the viscosity is generally about 50 centipose or less and desirably about 25 or less or about 10 centipose or less.

Various salts or mixtures thereof are utilized which are known to the art and to the literature that are highly soluble in water and thus create desired, predetermined specific gravities as low as about 1.001 or about 1.1 to as high as about 2.0 or about 3.0.

Suitable salts preferably are not corrosive or detrimental to the granulated particles, are capable of achieving a desired specific gravity for the particular operation stage, and produce a desired low viscosity. The salts or mixtures thereof are generally defined as ionic compounds containing an electropositive component and an electronegative component. Examples of positive components such as ions include alkali metals such as sodium and potassium, alkaline earth metal such as magnesium and calcium, and various transition metals (groups 3-15 of the periodic table) such as aluminum, tin, iron, zinc, and the like. The negative components such as ions include halogens such as chloride, oxygen or oxygen-containing compounds such as oxide, or hydroxide, or carbonate, nitrogen-containing compounds such as nitrate, phosphorus containing compounds such as phosphates, sulfur containing compounds such as a sulfate, or the non-metal portion of a metal complex, and the like. Examples of specific suitable salts include potassium carbonate, zinc chloride, ferric chloride, ferrous chloride, calcium chloride, calcium sulfate, zinc sulfate, zinc oxide, sodium chloride, sodium hydroxide, sodium zincate, magnesium chloride, various polytungstate complexes such as hydrated sodium heteropolytungstates, and mixtures thereof, with calcium chloride being preferred.

A small amount of a soap, surfactant, detergent, or wetting agent is desirably utilized to reduce surface tension, to hinder crystallization of the salt, to promote the release of air bubbles and to reduce the attraction between particles. Generally any conventional soap, surfactant, etc., can be utilized such as household soaps, laundry detergents, industrial detergents, and the like.

It has been unexpectedly found that the addition of surfactants, detergents and wetting agents to the aqueous solutions control surface tension and lower the freezing point thereof so that higher density or specific gravity solutions can be formed than otherwise possible. Depending upon the amount and type of surfactant, etc., the freezing point of a solution having a particular specific gravity can be depressed or reduced anywhere from about 0.1° F. to about 30° F.; desirably from about 1.0° F. to about 25° F.; and preferably from about 2.0° F. or about 3.0° F. or about 5.0° F. to about 10° F. or about 15° F., or about 20° F.

Surfactants can generally be anionic, cationic, nonionic, amphoteric, and the like and the same are known to the art and to the literature. Examples of suitable cationic surfactants include the various quaternary amines such as a quaternary ammonium salt having four alkyl and/or aryl bonds connected to the nitrogen atom wherein, independently, each hydrocarbon or functional containing hydrocarbon group has from 1 to 100 carbon atoms. Examples of suitable quaternary ammonium salts are known to the art and to the literature. Examples of other surfactants are set forth in 2003 McCutheon's Volume 1: Emulsifiers & Detergents (The Manufacturing Confectioner Publishing Company; Glen Rock, N.J.) which is hereby fully incorporated by reference. Whether a surfactant is suitable or not can be readily determined by adding various amounts to the aqueous solution containing particles of the various components and determining whether the particles are wetted out. Anionic surfactants ordinarily comprise alkyl hydrophobic hydrocarbon chains having terminal anionic hydrophilic polar groups such as carboxylate, sulfonate, sulfate, phosphonate and phosphate polar groups. The alkyl can contain from about 2 to about 24 carbon atoms and desirably from about 8 to about 20 carbon atoms. Suitable surfactants comprise fatty acid chains containing about 10 to about 20 carbon atoms and may contain one or more double bonds, if desired, as in naturally occurring fatty acid vegetable oils. Carboxylate surfactants ordinarily comprise alkyl hydrocarbon hydrophobic chains whereas sulfonate surfactants comprise alkyl, aryl, or alkyl-aryl hydrophobic chains which may contain double bonds, ester or amide groups.

Desired surfactants include the following: Sodium Caprylamphopropionate (Miranol JEM), Sodium 2-ethylhexyl sulfate (Rhodapon BOS, Sulfotex OA), sodium octyl sulfate (Standapol LF), Sultech 2113, Disodium Cocoamphodiacetate (Mackam 75/2C), Disodium Capryloamphodipropionate (Mackam 2CYSF), Cocamidopropyl Hydroxysultaine (Mackam CBS 50), Sodium Capryloamphohydroxypropylsufonate (Mackam JS), Caprylamidopropyl Betaine (Mackam OAB, DV 6836), methyl ester soybean oil (Septosol SB-D), Diphenylene Oxide Disulfonate (Rhodacal DSB), Lauraminopropionic Acid (Deriphat 151C), alkylpolyglucosides (Glucopon 425), Sodium laurylether sulfate (SLES), Octylamine Oxide (Mackamine C-8), octyl betaine (Mackam BW 139), Sodium Alkyl Naphthalene Sulfonate (Petro ULF), linear alkylbenzene sulfonates (Biosoft S-101), Lauramine Oxide, alkylamine oxides (AO 728), alkylether sulfonates (Avanel S-74), anionic and nonionic fluorosurfactants such as the various Zonyl surfactants made by DuPont, (e.g. Zonyl FS-62, FSA, FSP, FSE, FS-62, 9361, FSH, FSO, FSN, etc.), cationic/nonionic surfactant blends (Burcoterge CSB), alkylpolyglucosides (AG 6202), tall oil based amides (Burcoimidozoline), propoxylated and ethoxylated fatty acids (Burcoterge LFE 1000), modified ethoxylated carboxylates (Deterge LF 7315), phosphated amphoterics (Deteric CSP), ethoxylated complex amines (Deterge AT 100), diphenyl sulfonate derivatives (Dowfax 8390), phosphate esters (Colatrope 555, Colafax 3373 PE, Colafax 3371 PE), alkylether hydroxysultaines (Mirataine ASC), anionic proprietary blends (Colonial ZF 20), diphenyl sulfonate derivatives (Surfedon LP 300), organic phosphated amphoteric (Deteric CSP), salts of N-lauryl beta iminodiproprianate (Deriphat 160C), iminodipropionate amphoteric (Amphoteric 400), proprietary hydrotropes (Monatrope 1250), Cocamide DEA (Ninol 40-CO) and dodecylbenzene sulfonic acid (Biosoft S 101), wherein the number of carbon atoms in any alkyl group is as noted above.

Another compound which has been found to reduce the surface tension as well as to lower the freezing point of the aqueous salt solution are various defoamers which are known to the art and to the literature. Examples of suitable defoamers include compounds containing amorphous silica, various siloxanes such as polydimethyl siloxane, and the like such as Dow Corning 200, 1430, 1520, etc.

The amount of such surfactants, detergents, wetting agents, defoamers, etc., generally varies according to specific gravity desired and/or the amount of freezing point depression desired with generally-greater proportional amounts yielding a higher specific gravity and/or a larger freezing point depression.

The hydrogravity separation tank is designed to promote good separation of the multiple domain thermoplastic feedstocks after it is granulated. As a general concept of the present invention, one or more of the heaviest components are removed from the bottom of the hydrogravity separation tank as a slurry, and one or more of the lightest particles float to the top of the tank and are removed or skimmed off. The specific gravity of the solution in the tank is thus generally intermediate of the one or more heaviest and the one or more lightest density particles. Accordingly, the specific gravity is at least about 0.05 lighter or heavier and preferably at least about 0.10 or about 0.15 lighter or heavier than the specific gravity of any selected component particles. Preferably, in any given stage of the reclaiming operation, substantially only a single heaviest particle component is removed from the bottom or only a single lightest component is removed from the top of the separation tank with the remaining particles being removed from the opposite end of the tank. As noted above, it is an important aspect of the present invention that in order to obtain a high yield and purity of any specific particles of one or more components, such selected particles are feed to a plurality or multiple of subsequent hydrogravity separation tanks wherein the removal operation is repeated with the selective component being reclaimed being transferred to all the tanks in one operation stage. The number of such hydrogravity tanks in any operation stage can vary from at least 2 to about 10, desirably from about 3 to about 8, and preferably from about 3 to about 5 until the selected component(s) is highly purified. Naturally, the specific gravity of the aqueous solutions in any plurality of hydrogravity separation tanks of any single operation stage is substantially the same.

An essential aspect of the hydrogravity tanks is that they have a non turbulent or slow flow rate such that the tank effectively separates the heaviest component(s) or separates the lightest component(s) from the remainder of the solution. Such a quiescent tank has sides and bottom surfaces which are greater than the angle of repose of the particles thus eliminating and preventing build up thereof. The angle of repose of the various sides will vary with the physical and chemical properties of the solution, the types of components such as plastic or metal, the shape of the particles, and the like. However, such angles of repose can be readily determined by one skilled in the art. Generally, any side surface or wall of the tank has an angle A or B of at least 45 degrees from the horizon. The angle of the various sides is generally at least 1 degree greater, desirably at least 5 degrees greater, and preferably at least about 10 degrees greater than the angle of repose.

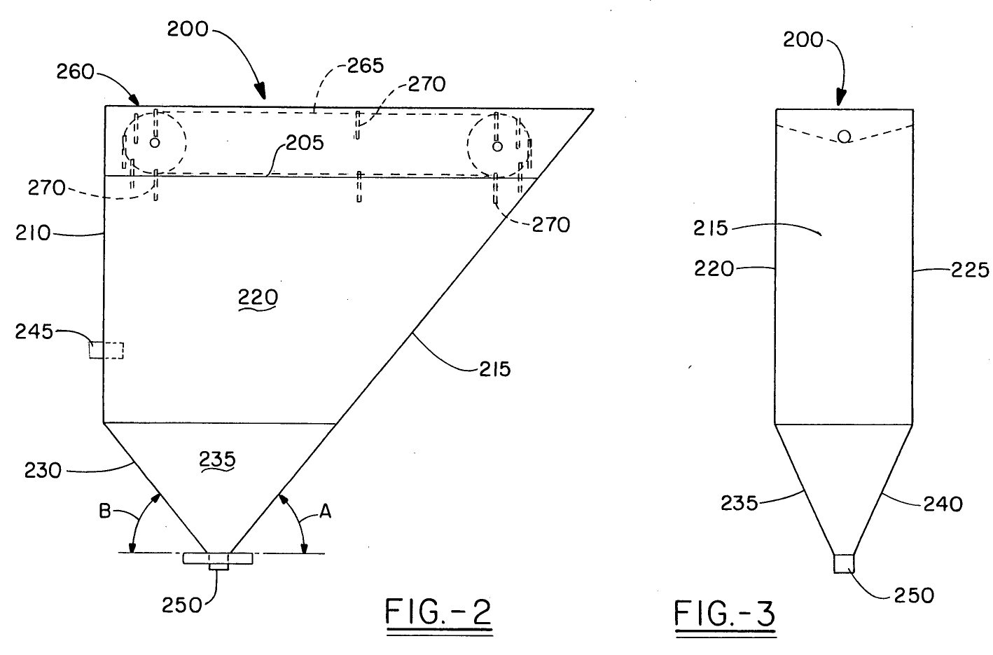

As long as the above requirements are met, numerous tank designs and configurations exist. One such configuration of a generalized tank of the present invention is set forth in FIG. 2 wherein tank 200 has a top 205, a vertical upper first end wall 210, an inclined upper second end wall 215, and as shown in FIG. 3, generally vertical upper first and second side walls 220 and 225 respectively. The upper first end wall 210 of the upper portion of the tank extends into inclined lower first end wall 230. As shown in FIG. 3, the upper first side wall 220 also merges into an inclined lower first side wall 235 and the same is true of upper second side wall 225 which merges into inclined lower second side wall 240, all of which are greater than the angle of repose.

Utilization of the above described hydrogravity separation tank of FIG. 2 thus permits the washed and dewatered particles from dryer 170 to be fed through tank inlet 245 to tank 200 and subsequently separated into components, such as at least one component which is discharged as a slurry from the tank bottom egress 250. The aperature size of egress 250 is sufficient to maintain a fairly constant and continuous aqueous solution removal and can be readily controlled by any conventional valve. The aperature size is also such that a sufficient particle residence time exists to permit efficient separation of the one or more heavier components and to achieve an aqueous solution velocity flow which avoids back mixing, entrainment, and the like.

As shown in FIG. 2, hydrogravity separation tank 200 in one embodiment optionally can contain skimmer 260 which comprises a conveyor type belt 265 having paddles 270 dependent therefrom. Rotation of conveyor 265 will cause the paddle to be immersed into the top of the aqueous solution and skim the floating particles to one edge of the tank where they are collected and transferred to mixing apparatus 300. Otherwise, the floating particles can simply flow through an outlet opening, weir or other types of removal devices known to the art and to the literature to the next stage of the system or process.

According to the concepts of the present invention, separation and purification of granulated solids of different components, e.g. plastic, metal, is conducted as opposed to purification of a solution. Separation of the various components are readily achieved when each feedstock component has a specific gravity at least about 0.05, and desirably at least about 0.10 or at least about 0.15, different from another component.

Inasmuch as the various granulated particles upon immersion into an aqueous solution will tend to agglomerate due to surface tension or electrostatic attraction, it is desirable to utilize a dispersion mixer before each separation tank to disperse, sever, etc., such agglomerated particles.

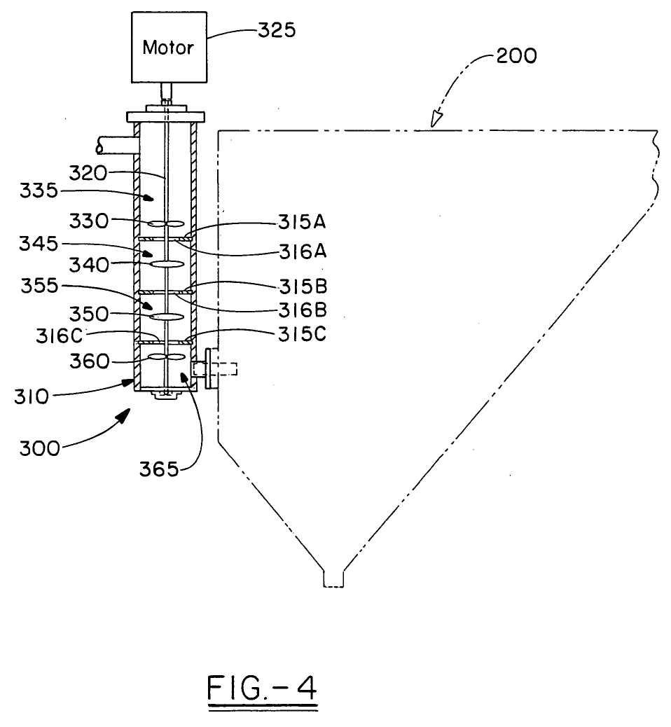

A dispersion mixer 300 shown in FIG. 4 is preferably located before the first hydrogravity tank of the first removal stage and desirably also before every hydrogravity tank therein. The same principle is true with respect to the other removal stages of other component particles. Although dispersion mixer 300 can be a batch mixer, it is highly preferred that a continuous flow mixer be utilized. The dispersion mixer can be of any shape but desirably is elongated and can have one or more mixing zones, with a plurality of zones, such as from about 2 to about 10, and from about 3 to about 5 zones being preferred. Desirably dispersion mixer 300 is in the shape of an elongated tube or cylinder 310 and has a zone separation element such as an annulus 315 located between and defining each zone. Annulus aperatures 316A, 316B and 316C can vary from zone to zone so long as it is less than the tube diameter with a desired aperature area of from about 10% to about 50% and preferably from about 15% to about 30% or about 35% of the total tube diameter area. The linear location of each zone separation annulus 315 can vary so that each zone can be of any desirable length and each zone length need not be the same. The zone length to diameter ratio can be of from about 0.5 or about 0.8 to about 5 or about 10.

One or more shafts can be utilized to rotate a mixing impeller, with one axial shaft 320 being preferred, which extends through mixer 300 and can be rotated by any conventional apparatus such as motor 325. Generally two types of mixing-impellers are utilized. The first is an axial mixing impeller 330, located in axial flow zone 335, which sucks in and propels the granulated component particles into the mixer. While a plurality of mixing impellers can be contained in any zone, desirably only one mixing impeller is utilized in each zone. Any conventional impeller can be utilized in the first or ingress zone such as a marine propeller having two or more blades, or any other substantially axial flow generating impeller.

The aqueous solution containing the granulated particles therein is then forced through first annulus 315A into first radial flow zone 345 which contains a second type of mixing impeller, a radial flow dispersion impeller 340 designed to break up substantially any particles which have agglomerated. It is essential that the radial flow dispersion impeller create high shear and/or high turbulence to separate the agglomerated particles. Such impeller dispersion blades are more functional than a simple impeller inasmuch as the dispersion blades create a hydraulic action which tears agglomerated particles apart and disperses them uniformly throughout the solution. This is believed to be achieved by two different mechanisms. In the first, agglomerated particles hitting the blade are broken apart (sheared) and then in the intense turbulence surrounding the blade, particles hit one another at high speeds and are further broken up. This intense turbulence around the blade generally occurs at a zone extending a couple of inches outward therefrom and is called the zone of attrition. Beyond the turbulent zone the various particles are thoroughly mixed and dispersed. The diameter of the high sheer and/or turbulent impeller 340 can vary in length but is generally from about 20% to about 50% and desirably from about 25% or about 30% to about 35% or about 40% of the dispersion mixer diameter. Various types of radial dispersion impeller blades are known to the art and to the literature and can be utilized such as a Cowles® impeller, a Hockmeyer impeller, or a so-called “high vane blade”.

In a preferred embodiment of the present invention, the aqueous solution is fed from first radial flow zone 345 through second zone separation annulus 315B to a second radial flow zone 355 having a dispersion impeller 350 which further breaks up the agglomerated particles, etc., and further disperses the same into individual particles. The mechanisms are the same as with regard to first radial flow zone 345 and hence will not be repeated.

In a preferred embodiment, the aqueous solution having a desired specific gravity flows through third zone separation annulus 315C into a fourth zone, which is a second axial flow zone 365 containing axial flow impeller 360. The axial flow impeller is desirably the same as axial flow impeller 330 and the same, along with the various other aspects of axial flow zone 365, will not be repeated but rather incorporated by reference with respect to the first axial flow zone 335. Of course, axial flow zone 365 serves to suck the aqueous solution from radial zone 355 into axial zone 365 and then expel it as through an egress in the mixer to a pipe or conduit leading to a subsequent hydrogravity separation tank and preferably to a mid-portion side inlet thereof.

The rpm of rotating shaft 320 can vary considerably depending upon desired throughput or flow rate but generally is from about 500 to about 5,000 and preferably from about 2,500 to about 3,500 rpm. The flow rate through mixer 300 will generally vary with the tube diameter as well as the diameter of aperatures 316A, 316B, and 316C and can be from about 1 to about 50, desirably from about 10 to about 45, and preferably from about 20 to about 40 gallons per minute with respect to a dispersion mixer having a 10 inch diameter.

While a specific dispersion mixer has been described in detail, it is to be understood that many variations thereof as well as other mixers can be utilized so long as they generally contain at least one and preferably a plurality of dispersion zones which serve to further break up the particles as through high shear and turbulence.

For example, a dispersion mixer can contain an inlet pump and/or an outlet pump in lieu of an impeller. Moreover, in the radial flow zones, high turbulence pumps can be utilized or a pump can be run backwards to produce high turbulence and/or shear.

### Hydrogravity Separation

The hydrogravity separation of a specific wire cable feed stock will now be discussed in view of the above principles, concepts, structures, and 10 descriptions. As noted above, the wire cable comprises a plurality of copper wires each surrounded with a polyethylene thermoplastic with the same being encapsulated in polyvinyl chloride thermoplastic insulation. The outer jacket of the insulated cable is a nylon thermoplastic. In the preferred separation embodiment, only one component is separated in each stage or operation with the remaining components being purified transferred to the next stage.

The granulated, washed, and dewatered feedstock is fed to first dispersion mixer 415 which, is described herein above, the description, concepts, principles, etc. which are hereby incorporated by reference, contains a plurality of zones having a first axial flow zone, a first dispersion zone wherein a dispersion impeller breaks up agglomerated particles as by high shear and/or turbulence, a second radial dispersion zone followed by an axial output zone. The dispersed particles are then fed to a mid-portion of a first hydrogravity separation tank 410, the description, concepts, principles, etc., of which as set forth herein above such as with regard to tank 200 are hereby fully incorporated by reference. The specific gravity of the aqueous solution in tank 410, and all subsequent tanks 420, 430 and 440, is about 1.40 which is greater than all of the thermoplastic domains or components but less than that of the copper component. The viscosity of the calcium chloride aqueous solution is low, for example less than about 10 centipose. The sides of tank 410 have an angle sufficient to prevent buildup of any copper solids and the flow rate throughout the tank is slow and generally free of any turbulence so that quiescent separation is achieved. That is, generally there is a slow flow of a velocity component in the horizontal direction with a greater velocity flow component in either vertical direction. After a desired residence time to permit good separation, the copper particles are emitted from the bottom of tank 410 in the form of a slurry which is transferred to conventional purification unit 470. Any conventional purification unit can be utilized such as a concentrating table, e.g. a Deister or a Wilfley table, generally of a rectangular shape and tilted towards one corner so the copper particles are directed thereto and collected. The remaining thermoplastic domain particles of nylon, PVC and polyethylene either flow out of the top of the tank as through a weir or are skimmed off and fed to second dispersion mixer 425. The second dispersion mixer is desirably the same as the first mixer and thus has two radial flow zones for breaking up and separating various agglomerated particles which are primarily a thermoplastic. The various thermoplastic component particles are then fed to a second hydrogravity separation tank 420, and desirably to a middle portion side inlet thereof.

Tank 420 preferably contains the same specific gravity aqueous solution as first separation tank 410 and in all aspects is desirably the same as first tank 410. In other words, the structure, flow, etc., can be a duplicate of the first hydrogravity separation tank. Thus, additional settled copper particles from the bottom of tank 420 are fed to purification unit 470 and the remaining floating particles are either skimmed or flow to third dispersion mixer 435 which is desirably the same as first dispersion mixer 415 and has multiple axial mixing zones, and multiple dispersion zones which further break up agglomerates.

In a similar manner, the system and process can be repeated any number of desirable times until essentially all of the copper component has been removed from the hydrogravity separation tanks which all contain essentially the same structure and conditions as well as the same specific gravity aqueous solution as first tank 410, with the remaining thermoplastic particles being removed from the top of the tank and passed through a mixer having the same structure and conditions as first dispersion mixer 415 and then transferred to a succeeding tank. In the embodiment shown in FIG. 1, a total of four tanks are utilized including third hydrogravity separation tank 430, fourth dispersion mixer 445, and fourth hydrogravity separation tank 440.

In accordance with the concepts of the present invention, inasmuch as only copper was removed from the first operation stage, the remaining thermoplastic components are purified in that they are subjected to a plurality of dispersion mixers and hydrogravity separation tanks and contain very little, if any, remaining copper particles therein.

After the last tank or mixer of the copper separation stage, the aqueous slurry is fed to dewaterer 460 to remove the high specific gravity aqueous solution from the plastic particles and the solution returned to tank 410 (not shown) so that no significant amount thereof is sent to the second purification or operation stage which would alter the specific gravity of the subsequent stage and potentially have a detrimental effect thereon. Generally any conventional dryer or dewaterer 460 can be utilized such as a fluid bed, a vibration screen, or a centrifuge dryer, with a spin dryer such as a Gala 3016 dryer manufactured by Gala Corporation being suitable.

The utilization of the above system and process with regard to a copper cable can result in a yield of generally at least 90%, desirably at least about 95% and preferably at least about 98% or about 99% percent by weight from copper purification unit 470 based upon the total weight of copper added to first separation tank 410. The purity of copper from purification unit 470, which separates thermoplastic particles from the copper, is generally at least about 80%, desirably at least about 90%, and preferably at least about 95% or at least about 98% by weight based upon the total weight of material collected.

Considering the second operation stage of the system and process of the present invention, the purified thermoplastic particles obtained from the first stage or operation are fed to a plurality of a dispersion mixer and subsequent hydrogravity separation tank units desirably in accordance with the concepts, principles, structure and the description set forth hereinabove and for the-sake of brevity will not be repeated. However, the same is hereby fully incorporated by reference with regard to all aspects thereon such as to the structure, shape, flow conditions of the various hydrogravity tanks, the type of dispersion mixers which utilize a plurality of zones having at least one axial flow zone and at least radial dispersion zone.

In the second operation stage of the reclaiming system and process, PVC is purified by collecting it from the bottom of each tank and feeding it to a sequence of dispersion mixers and hydrogravity separation tanks. Any remaining domain thermoplastics such as polyethylene and nylon float to the top and are removed from each tank.

With respect to the three thermoplastic components derived from a copper cable, the PVC component has the highest specific gravity with nylon having a lower specific gravity and polyethylene the lowest. Accordingly, the specific gravity of each tank within the second operation stage is approximately the same and is approximately 1.2 which is slightly lighter than the PVC but heavier than the polyethylene and the nylon. The thermoplastic particles from the dewaterer 460 are thus fed to dispersion mixer 515 where they pass through different mixing zones separated by an annulus and are subjected to a dispersion impeller whereby an agglomerates of any of the three thermoplastic components are substantially broken into separate thermoplastic particles. The thermoplastic particles are then fed to quiescent hydrogravity tank 510 which have walls of non-repose and non-turbulent flow conditions with adequate residence times such that the various particles can separate from one another and subsequently the lighter polyethylene and nylon are collected from the top of tank 510 and directly fed to the third operation stage. The polyvinyl chloride particles are collected from the bottom of first tank 510, fed to second dispersion mixer 525 where they pass through different mixing zones and are subjected to a dispersion impeller whereby any agglomerates are substantially broken into individual thermoplastic particles. The particles are then fed generally to the middle portion of second hydrogravity tank 520 wherein the separation process is repeated. Thus, the lighter polyethylene and nylon particles float to the top and flow out of or are skimmed off the top of second tank 520 are then directly fed to the third operation stage. Any remaining PVC particles settle out of the bottom of second tank 520 and are fed to third dispersion mixer 535, and then to third hydrogravity tank 530 for further separation. Once again, in a manner as described hereinabove, the polyethylene and nylon particles are separated and collected from the top of tank 530 and fed directly-to the third operation stage. The PVC particles are collected from bottom of tank 530 and fed to fourth dispersion mixer 545 wherein agglomerates are severed and broken apart and fed to generally the middle of fourth hydrogravity separation tank 540. The fourth and last tank once again permits any remaining polyethylene and nylon particles to be directly fed to the third operation stage. The PVC thermoplastic polymers which are collected from the bottom of fourth separation tank 540 are washed and dried in any conventional manner as a fluid bed, a vibration screen, or a centrifuge 550, with the above noted Gala spin dryer being preferred. The PVC component particles are then bagged, etc. and placed in storage unit 560 for subsequent reuse and/or sale. The aqueous solution from dryer 550 is then recycled desirably to first hydrogravity tank 510.

In the third unit operation or stage, the thermoplastic components of nylon and polyethylene particles from the second unit operation are fed to first dispersion mixer 615 and then to hydrogravity separation tank 610. As with the prior two purification operations, the component which is desired to be cleaned or purified is recycled to a second dispersion mixer and tank, then to a third dispersion mixer and tank, and then to a fourth dispersion mixer and hydrogravity separation tank whereas the remaining thermoplastic polyethylene component is directly collected and dried as for reuse and/or resale. Once again, with respect to the overall system and process of the third unit operation, the concepts, principles, structures; and description as set forth hereinabove with regard to the mixers, the hydrogravity tanks, and the like are hereby fully incorporated by reference and hence will not be repeated.

The feed stream from the end of the second operation stage is fed to first dispersion mixer 615 wherein any agglomerated particles are substantially broken apart with the slurry then being fed to first hydrogravity separation tank 610 wherein the heavier nylon particles settle to the bottom of the tank and are collected, washed, and directly fed to nylon dryer 650. The specific gravity of the aqueous solution of all of the tanks of the third stage operation are all essentially the same and are all slightly less than the specific gravity of nylon and hence is approximately 1.0. Thus, as with the first and second operation stages, if any or a small amount of a thermoplastic component is contained with the heaviest component or an agglomerated particle containing more than one domain, it will float to the top whereupon it is de-agglomerated and fed to a subsequent tank, and so forth until all of the heaviest component has been removed therefrom. Accordingly, the particles which float to the top of first tank 610 are fed to second mixer 625 where agglomerated particles are broken apart, added to second hydrogravity separation tank 620 with the nylon collected from the bottom thereof and fed directly to nylon dryer 650 and the remaining floating polyethylene particles fed to third mixer 635. The process is once again repeated purifying the polyethylene particles by collecting the heavy nylon particles from the bottom of tank 630 and further breaking any agglomerated floating particles by feeding them to mixer 645. Finally, any remaining nylon particles are collected from the bottom of tank 640, washed, and dried in nylon dryer 650 with the remaining particles which float being purified polyethylene particles which are washed, and fed to polyethylene dryer 660. Both nylon dryer 650 and polyethylene dryer 660, as before, can be any conventional dryer such as a centrifuge dryer, a fluid bed, vibrating screen with a spin dryer such as a Gala dryer being preferred. The separate dried nylon particles can be collected in storage unit 670 for subsequent use and/or sale. The polyethylene particles can also be dried and placed in storage unit 680 for subsequent use and/or sale. As before, the collected aqueous solution from dryers 650 and 660 are recycled to hydrogravity 610 to replenish the aqueous solution thereof.

The above described system and process will be better understood by reference to the following example which serves to illustrate but not to limit the present invention.

With respect to reclamation of a copper cable containing 1,000 lbs. by weight of feedstock, and according to the format generally described hereinabove and shown in FIG. 1, 995 lbs. of feed stock was obtained from granulator 120 with the remaining 5 lbs. being recovered as fines. Depending. upon the amount of wire in the cable feedstock, the amount of copper recovered from first operation stage 400 can range from about 10 lbs. to about 150 lbs. with the purity of the copper being generally at least about 80%, at least about 90%, or at least about 95% by weight, and preferably at least about 98% or at least about 99% by weight. The recovery of the PVC from the second operation stage 500 can range from about 750 to about 975 lbs. with the purity of the PVC being at least about 85% to at least about 90% or, desirably at least 95% by weight, and preferably at least about 98% or at least about 99% by weight of the total weight of the collected PVC stream.

The amount of the nylon and polyethylene being recovered from the third operation stage 600 each can independently vary from about 5 lbs. to about 100 lbs. based upon the total weight of both components with the purity of each component being at least 85% or at least about 90% by weight, desirably at least about 95% by weight, and preferably at least about 98% or at least about 99% by weight.

Generally, the system and process of the present invention readily recovers at least about 95%, desirably at least about 98%, and preferably at least about 99% by weight of the initial feedstock.

If desired, each of the above reclaimed component particles of PVC, polyethylene, and nylon can be further purified by other methods known to the art and to the literature if so desired.

While the above invention has been described with regard to a copper cable feed stock, it is understood that generally any type of solid feed stocks which are not melt blended, can be utilized including feedstock containing various metals such as aluminum cable, etc.

While in accordance with the Patent Statutes, the best mode and preferred embodiments have been set forth, the scope of the invention is not limited thereto, but rather by the scope of the attached claims.

1. A hydrogravity process for reclaiming a thermoplastic feedstock, comprising the steps of:
granulating a solid feedstock comprising a plurality of domains having different densities into a mixture of particles each of which comprises substantially a single domain component;
adding said granulated feedstock to a first binary hydrogravity separation tank having an aqueous solution specific gravity intermediate to one or more higher density heavier feedstock component particles and intermediate to one or more lighter feedstock component particles;
separately removing said heavier feedstock component particles and said lighter feedstock component particles;
selecting and feeding either said heavier or said lighter feedstock component particles to at least one additional sequential hydrogravity separation tank having substantially the same specific gravity as said first hydrogravity separation tank and removing said selected component particles therefrom; and
collecting said selected purified component particles.

2. A hydrogravity reclaiming process according to claim 1, wherein said feedstock components comprise at least one inorganic filler, at least one metal, at least one type of wood, at least one type of paper, or at least one type of plastic, or combinations thereof, wherein said plastic is at least one homopolymer or copolymer of a thermoplastic, or a homopolymer or copolymer of a thermoset;
wherein the number of sequential hydrogravity separation tanks is from about 2 to about 10; and
including feeding said selectively removed component particles to a dispersion mixer and substantially dispersing any agglomerated component particles.

3. A hydrogravity reclaiming process according to claim 2, wherein said intermediate specific gravity of said aqueous solution in each hydrogravity tank is substantially the same, wherein said intermediate specific gravity of said aqueous solution is at least 0.05 different than said selected one or more heaviest or lightest component particles;
wherein the specific gravity of each feedstock component particles is at least 0.05 different than any other feedstock component;
wherein the viscosity of said aqueous solution in each tank is less than about 50 centiposes; and
wherein said dispersion mixer has at least one dispersion zone.

4. A hydrogravity reclaiming process according to claim 3, wherein said specific gravity of said aqueous solution is at least 0.10 different than said selected one or more heaviest or lightest component particles, wherein the number of said hydrogravity separation tanks is from about 3 to about 8, and including utilizing said dispersion mixer before each said hydrogravity separation tank.

5. A hydrogravity reclaiming process according to claim 4, wherein said granulated feedstock comprises a copper component, a thermoplastic polyvinyl chloride component, a thermoplastic nylon component, and a thermoplastic polyolefin component;
wherein said specific gravity of said aqueous solution is less than only said heaviest feedstock component particles; and
removing only said heaviest component particles from the bottom of each said hydrogravity separation tank and recycling said remaining thermoplastic particles to each said sequential separation tank.

6. A hydrogravity reclaiming process according to claim 1, wherein the purity of said collected, selected thermoplastic component particles is at least 95% by weight.

7. A hydrogravity reclaiming process according to claim 4, wherein the purity of said collected, selected thermoplastic component particles is at least 99% by weight.

8. A hydrogravity reclaiming process according to claim 1, comprising the steps of feeding particles of said non-selected remaining feedstock components to a hydrogravity separation tank having an aqueous solution specific gravity less than only a selected remaining heaviest thermoplastic feedstock component or greater than only a selected remaining lightest thermoplastic feedstock component;
removing said selected remaining thermoplastic component particles;
feeding said selected remaining feedstock component particles to at least one additional hydrogravity separation tank having substantially the same specific gravity as said prior hydrogravity separation tank and removing said second selected remaining feedstock component particles therefrom; and
collecting said selected remaining purified feedstock component particles.

9. A hydrogravity reclaiming process according to claim 3, comprising the steps of feeding particles of said non-selected remaining feedstock components to a first hydrogravity separation tank having an aqueous solution specific gravity less than only a selected remaining heaviest thermoplastic feedstock component or greater than only a selected remaining lightest thermoplastic feedstock component;
removing said selected remaining thermoplastic component particles;
feeding said selected remaining feedstock component particles to at least one additional hydrogravity separation tank having substantially the same specific gravity as said prior hydrogravity separation tank and removing said second selected remaining feedstock component particles therefrom; and
collecting said selected remaining purified feedstock component particles.

10. A hydrogravity reclaiming process according to claim 5, comprising the steps of feeding particles of said non-selected remaining feedstock components of said PVC, said polyethylene and said nylon to a first hydrogravity separation tank having an aqueous solution specific gravity greater than only the selected PVC thermoplastic feedstock component;
removing said selected PVC thermoplastic component particles;
feeding said selected PVC feedstock component particles to at least one additional hydrogravity separation tank having substantially the same specific gravity as said prior hydrogravity separation tank and removing said selected PVC feedstock component particles therefrom; and
collecting said selected purified PVC feedstock component particles.

11. A hydrogravity reclaiming process according to claim 1, wherein said aqueous solution comprises water and one or more salts.

12. A hydrogravity reclaiming process according to claim 4, wherein said aqueous solution comprises water and one or more salts, wherein said salt contains a positive component comprising an alkali metal, an alkaline earth metal, or a transition metal, or combinations thereof, and a negative component comprising a halogen, oxygen, or an oxygen-containing compound, a phosphorus containing compound, a nitrogen-containing compound, a sulfur containing compound, the non-metal portion of a metal complex, or combinations thereof.

13. A hydrogravity reclaiming process according to claim 5, wherein said aqueous solution comprises water and a salt comprising potassium carbonate, zinc chloride, ferric chloride, ferrous chloride calcium chloride, calcium sulfate, zinc sulfate, zinc oxide, sodium chloride, sodium hydroxide, sodium zincate, polytungstate, magnesium chloride, or combinations thereof.

14. A hydrogravity reclaiming process according to claim 9, wherein said aqueous solution comprises water and a salt comprising potassium carbonate, zinc chloride, ferric chloride, ferrous chloride calcium chloride, calcium sulfate, zinc sulfate, zinc oxide, sodium chloride, sodium hydroxide, sodium zincate, polytungstate, magnesium chloride, or combinations thereof.

15. A system for reclaiming a feedstock, comprising:
a plurality of hydrogravity separation tanks; each said tank adapted to receive at least a plurality of feedstock domains in the form of feedstock component particles, each particle containing substantially only one component;
each said separation tank containing an aqueous solution having substantially the same specific gravity intermediate to one or more heavier feedstock component particles and intermediate to one or more lighter feedstock component particles;
each said separation tank adapted to separate said one or more heavier feedstock component particles from said one or more lighter feedstock component particles from said feedstock,
a plurality of dispersion mixers, at least one said mixer located before at least one said separation tank; and said dispersion mixer having at least one dispersing zone for substantially dispersing any agglomerated feedstock component particles.

16. A system for reclaiming feedstock component particles according to claim 15, wherein the number of said hydrogravity separation tanks is from 2 to about 10, and wherein the specific gravity of said aqueous solution is 0.05 less than said selected one or more heavier feedstock component particles or 0.05 greater than said selected one or more lighter feedstock component particles.

17. A system for reclaiming feedstock component particles according to claim 16, wherein the viscosity of said aqueous solution is less than about 50 centipose, wherein said aqueous solution comprises at least one salt; and
wherein each said mixer is located before each said hydrogravity separation tank for receiving said selected feedstock component particles.

18. A system for reclaiming feedstock component particles according to claim 15, wherein said aqueous solution comprises water and one or more salts, wherein said salt contains a positive component comprising an alkali metal, an alkaline earth metal, or a transition metal, or combinations thereof, and a negative component comprising a halogen, oxygen, or an oxygen-containing compound, a phosphorus containing compound, a nitrogen-containing compound, a sulfur containing compound, the non-metal portion of a metal complex, or combinations thereof; and
wherein said system is capable of purifying said selected thermoplastic component particles to a purity of at least about 90% by weight.

19. A system for reclaiming feedstock component particles according to claim 16, wherein said aqueous solution comprises water and a salt comprising potassium carbonate, zinc chloride, ferric chloride, ferrous chloride calcium chloride, calcium sulfate, zinc sulfate, zinc oxide, sodium chloride, sodium hydroxide, sodium zincate, polytungstate, magnesium chloride, or combinations thereof.

20. A system for reclaiming feedstock component particles according to claim 17, wherein said aqueous solution comprises water and a salt comprising potassium carbonate, zinc chloride, ferric chloride, ferrous chloride calcium chloride, calcium sulfate, zinc sulfate, zinc oxide, sodium chloride, sodium hydroxide, sodium zincate, polytungstate, magnesium chloride, or combinations thereof; and
wherein said feedstock components are plastic components, wherein said plastic component is one or more homopolymers or copolymers of a thermoplastic, or a homopolymer, or a copolymer of one or more thermoset polymers, or combinations thereof, and wherein said specific gravity of said aqueous solution is less than only a selected heaviest plastic feedstock component particles or greater than only a selected lightest plastic feedstock component particles.

21. A process for separating feedstock particles, comprising the steps of:
feeding a plurality of different feedstock component particles to a side inlet of a hydrogravity separation tank having an aqueous solution therein, said tank having a bottom outlet and a top outlet, said tank having a plurality of side walls the angle of inclination with respect to the horizontal of each said side wall being greater than the angle of repose of any of said feedstock particle in said aqueous solution; a plurality of said feedstock components having a different specific gravity than any other feedstock component; said aqueous solution having a specific gravity less than only the heaviest feedstock component particles or greater than only the lightest feedstock component particles; and
hydrogravity separating either only said lightest component particles from the top of said tank or separating only said heaviest component particles from the bottom of said tank.

22. A process according to claim 21, wherein the specific gravity of a particular feedstock component particle is at least 0.05 less or greater than another feedstock component particle;
wherein said angle of repose of any said side wall is at least 45 degrees with respect to said horizontal; and
wherein said side tank inlet is located from about 10% to about 90% of said tank height.

23. A process according to claim 22, wherein said feedstock component comprises at least one homopolymer or copolymer thermoplastic, or at least one homopolymer or copolymer thermoset, or combinations thereof, and wherein the specific gravity of said aqueous solution is at least 0.10 less than 43 said heaviest plastic component particle or 0.10 greater than the lightest thermoplastic component particle.

24. A process according to claim 23, wherein said side inlet is located from about 30% to about 70% of said tank height, and wherein the viscosity of said aqueous solution is about 50 centipose or less.

25. A process according to claim 21, wherein said plurality of thermoplastic component particles comprise one or more inorganic fillers, one or more metals, one or more thermoplastic polymers, one or more thermoset polymers, one or more different types of wood, one or more different types of paper, and combinations thereof.

26. A process according to claim 24, wherein said plurality of thermoplastic component particles comprise at least two thermoplastic polymers, wherein said thermoplastic polymers include polyolefins; styrenic polymers; acrylic polymers; polyvinyl esters; polyvinyl alcohol; chlorine-containing polymers; various fluorocarbon polymers; polyamides; polyesters; polyurethanes; polycarbonates; copolymers of the above, or combinations thereof.

27. A process according to claim 21, wherein said aqueous solution comprises water and at least one salt.

28. A process according to claim 23, wherein said aqueous solution comprises water and a salt comprising potassium carbonate, zinc chloride, ferric chloride, ferrous chloride calcium chloride, calcium sulfate, zinc sulfate, zinc oxide, sodium chloride, sodium hydroxide, sodium zincate, polytungstate, magnesium chloride, or combinations thereof.

29. A process according to claim 24, wherein said aqueous solution comprises water and a salt comprising potassium carbonate, zinc chloride, ferric chloride, ferrous chloride calcium chloride, calcium sulfate, zinc sulfate, zinc oxide, sodium chloride, sodium hydroxide, sodium zincate, polytungstate, magnesium chloride, or combinations thereof.

30. A hydrogravity tank for separating thermoplastic particles comprising:
a tank adapted to receive an aqueous solution, said tank having a side inlet, a bottom outlet and a top outlet;
the aqueous solution adapted to receive at least three different solid feedstock components each having a different specific gravity, the aqueous solution adapted to have a specific gravity less than only the heaviest feedstock component or greater than only the lightest feedstock component; and
said tank having side walls, each said side wall having a angle of inclination with respect to the horizon so that said feedstock particles in the aqueous solution are not capable of being reposed on said tank side walls.

31. A multiple stage dispersion mixer for a feedstock, comprising:
an inlet;
an outlet;
a plurality of mixing zones between the inlet and outlet;
a zone separation element located between adjacent mixing zones, each said zone separation element having an aperature adapted to allow fluid travel between adjacent mixing zones; and
a mixing impeller located in each mixing zone, wherein at least one of the mixing impellers is a radial flow dispersion impeller.

32. A mixer according to claim 31, wherein 2 to about 10 mixing zones are present, and wherein the aperature area ranges in an amount from about 10% to about 50% of the total zone separation element area.

33. A mixer according to claim 32, wherein 3 to about 5 mixing zones are present, and wherein the aperature area ranges in an amount from about 15% to about 35% of the total zone separation element area.

34. A mixer according to claim 32, wherein the mixer has a body which is substantially cylindrical in shape, wherein the zone separation element is annular.

35. A mixer according to claim 34, wherein each mixing zone has a length to diameter ratio of from about 0.5 to about 5.

36. A mixer according to claim 35, wherein the radial flow dispersion impeller has a diameter which is about 20% to about 50% of the mixer diameter, and wherein at least one of mixing zone utilizes an axial flow mixing impeller.

37. A mixer according to claim 36, wherein the mixing impellers are connected to a single shaft adapted to have a rotation of about 50 to about 5,000 RPM.

38. A mixer according to claim 36, wherein at least four mixing zones are present with at least two radial flow dispersion impellers and at least two axial flow mixing impellers being utilized.

39. A mixer according to claim 38, wherein four mixing zones are utilized with the first and fourth zones having axial flow mixing impellers and the second and third zones having radial flow dispersion impellers.

40. A mixer according to claim 31, wherein the mixer contains an aqueous solution comprising granulated thermoplastic particles.

41. A mixer according to claim 39, wherein the mixer contains an aqueous solution comprising granulated thermoplastic particles.

42. A mixer according to claim 31, wherein said feedstock components comprise at least one inorganic filler, at least one metal, at least one type of wood, at least one type of paper, or at least one type of plastic, or combinations thereof, wherein said plastic is at least one homopolymer or copolymer of a thermoplastic, or a homopolymer or copolymer of a thermoset.

43. A mixer according to claim 35, wherein said feedstock components comprise at least one inorganic filler, at least one metal, at least one type of wood, at least one type of paper, or at least one type of plastic, or combinations thereof, wherein said plastic is at least one homopolymer or copolymer of a thermoplastic, or a homopolymer or copolymer of a thermoset.

44. A mixer according to claim 31, wherein said granulated feedstock comprises a copper component, a thermoplastic polyvinyl chloride component, a thermoplastic nylon component, and a thermoplastic polyolefin component.

45. A mixer according to claim 37, wherein said granulated feedstock comprises a copper component, a thermoplastic polyvinyl chloride component, a thermoplastic nylon component, and a thermoplastic polyolefin component.

46. A mixer according to claim 31, wherein said granulated feedstock comprises a copper component and a polyethylene component, or a copper component and a blend of polyethylene and polypropylene.

47. A mixer according to claim 31, wherein said granulated feedstock comprises nylon and polytetrafluoroethylene.

48. A mixer according to claim 31, wherein said granulated feedstock comprises a copper component and a polytetrafluoroethylene component.
